(19) United States
(12) Patent Application Publication
(10) Pub. No.: US 2013/0024340 A1
(43) Pub. Date: Jan. 24, 2013

(54) Alternate Currency Derivatives

(71) Applicants: Richard Co, Chicago, IL (US); Steven Youngren, Elgin, IL (US); Kok Chong Lam, Singapore (SG); Scott Brusso, Oak Park, IL (US); John Labuszewski, Westmont, IL (US)

(72) Inventors: Richard Co, Chicago, IL (US); Steven Youngren, Elgin, IL (US); Kok Chong Lam, Singapore (SG); Scott Brusso, Oak Park, IL (US); John Labuszewski, Westmont, IL (US)

(73) Assignee: CHICAGO MERCANTILE EXCHANGE INC., Chicago, IL (US)

(21) Appl. No.: 13/285,502

(22) Filed: Oct. 31, 2011

Related U.S. Application Data
(63) Continuation-in-part of application No. 13/187,846, filed on Jul. 21, 2011.
Application No. 13/187,846 is a continuation-in-part of application No. 13/187,837, filed on Jul. 21, 2011.

(51) Int. Cl. G06Q 40/06

(52) U.S. Cl. 705/35

(57) ABSTRACT

An alternate currency futures contract or other type of derivative can be denominated in a primary currency. Margin account adjustments for mark-to-market (MTM) settlements, final settlements, and/or other cash flows associated with the contract can initially be calculated based on the primary currency, and then be converted to an alternate, secondary currency. This conversion can occur unconditionally and without requiring a prior unavailability determination.

### CROSS-REFERENCE TO RELATED APPLICATIONS

This application is a continuation-in-part of commonly-owned U.S. application Ser. No. 13/187,846, filed Jul. 21, 2011, and titled “Modification of Multi-Laterally Traded Contracts Based on Currency Unavailability Condition,” and is also a continuation-in-part of commonly-owned U.S. application Ser. No. 13/187,837, filed Jul. 21, 2011, and titled “Interest Accrual Provisions for Multi-Laterally Traded Contracts.” Each of said applications, in its entirety, is incorporated by reference herein.

### BACKGROUND

The modern global economy employs numerous types of contracts that are traded and/or cleared in a multi-lateral environment. For example, participants in exchanges or other markets routinely buy, sell and otherwise utilize futures contracts and futures contract options. Futures contracts and options are commonly used in connection with various agricultural and industrial commodities, in connection with currency exchange, etc.

There are various circumstances under which a party to a typical futures contract might be obligated to make some sort of payment. As but one example, a clearinghouse may require mark-to-market (MTM) payments on a periodic basis or when the current value of a futures contract is less than a certain percentage of a party's margin account with the clearinghouse. As another example, one party may purchase a contract from another party. Money may also be paid when a futures contract is settled. That final payment may be based on the final mark of a cash settled contract. The final payment might alternatively be the amount of an invoice for satisfying delivery of a particular financial instrument, commodity, currency, etc.

These and other payments must typically be made in a currency that is specified by the futures contract. A market generally assumes that such payments will be unimpeded by illiquidity in a market for the specified currency, inconvertibility of the specified currency, non-transferability of the specified currency, or other scenarios in which the specified currency might not be readily available. Although exchange rates of various currencies relative to one another may fluctuate, conventional futures contracts typically contemplate an unrestricted availability of a specified currency on commercially reasonable terms.

If adequate supplies of a specified currency are not available, it may be difficult to settle or otherwise make payments in connection with a futures contract. In the context of over-the-counter derivatives traded and carried on a bilateral basis, parties have been known to reach various accommodations on a contract-by-contract basis. For example, two parties might agree that settlement could be made in an alternative manner (e.g., paying an equivalent amount of a foreign currency) and/or deferred until a later date. However, there are qualitative and quantitative differences between bilaterally-traded derivatives and derivatives traded on a multi-lateral basis. Although it is often simple for two parties to work out an accommodation of an unforeseen currency contingency, futures contracts must account for the needs of a potentially large number of market participants.

In particular, futures contracts are typically standardized so as to facilitate selling, offsetting, and otherwise creating a functioning market for a contract of a particular type (e.g., for a particular commodity or for a particular foreign currency). At any one time there may be a large number of outstanding futures contracts of a particular type. Each of those contracts may have very similar terms (e.g., deliver a specified amount of a particular commodity or a specified amount of a particular foreign currency), but may involve different parties. Moreover, various subsets of those contracts may mature at different dates. Even if the parties to each individual contract could agree on an appropriate way to accommodate an unforeseen currency condition, the accommodations would not be uniform across all of those contracts. This would be undesirable, as participants in futures contracts of a particular type should be treated fairly and consistently if a market for such contracts is to function properly.

In some cases, a commodity, futures or other type of exchange can take emergency action that modifies how all existing contracts of a particular type will be settled or otherwise performed. This is also undesirable. Such emergency actions invoke substantial governmental reporting requirements, can undercut market confidence, and can have other detrimental side effects.

### SUMMARY

This Summary is provided to introduce a selection of concepts in a simplified form that are further described below in the Detailed Description. This Summary is not intended to identify key or essential features of the invention.

In some embodiments, an alternate currency futures contract or other type of derivative can be denominated in a primary currency. Margin account adjustments for mark-to-market (MTM) settlements, final settlements, and/or other cash flows associated with this type of contract are initially calculated based on the primary currency, but are then converted to an alternate, secondary currency. This conversion can occur unconditionally and without requiring a prior unavailability determination.

In some embodiments, a computer system can calculate, for each of a plurality of multilaterally-traded contracts, a change in contract value in an amount of a primary currency. The computer system can then convert, for each multilaterally-traded contract of the plurality, the change in contract value from the amount of the primary currency to an amount of a secondary currency using an exchange rate designated by the contract. The computer system can then update, for each multilaterally-traded contract of the plurality, and based on the calculated amount of the secondary currency, data in an account corresponding to a holder of an interest in the contract.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows a computer network system that may be used to implement aspects of the invention.

FIG. 2 is a block diagram of a system, according to some embodiments, for use in determining whether a currency unavailability condition exists.

FIGS. 3 and 4 illustrate methods, according to some embodiments, in which a currency unavailability condition is found to exist and in which action is taken as a result.

FIG. 5 illustrates a method, according to some embodiments, that may be performed in connection with a futures contract or other multi-laterally traded and/or cleared contract that designates primary and secondary currencies.

FIGS. 6A through 6C are block diagrams showing operations in connection with alternate currency derivatives according to some additional embodiments.

FIG. 7 illustrates a method, according to at least some additional embodiments, in which alternate currency derivatives can be traded and processed.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a data processing system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of tangible non-transitory computer readable storage media such as hard disks, CD-ROMs, optical storage devices, magnetic storage devices, and/or any combination thereof.

Aspects of method steps described in connection with one or more embodiments may be executed on one or more processors associated with an exchange computer system 100 and/or associated with other computers or computer systems. Such processors may execute computer-executable instructions stored on non-transitory computer-readable media. Embodiments may also be practiced in distributed computing environments where tasks are performed by remote processing devices that are linked through a communications network. In a distributed computing environment, program modules may be located in both local and remote computer storage media including memory storage devices.

### Exemplary Operating Environment

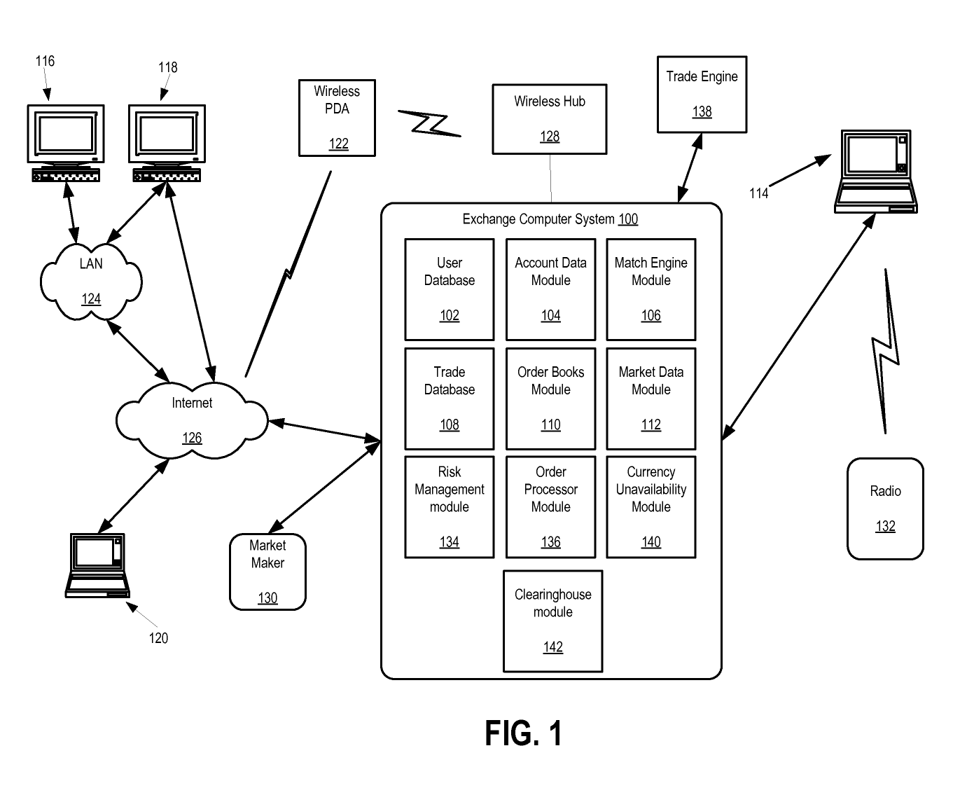

Aspects of at least some embodiments can be implemented with computer devices and computer networks that allow users to exchange trading information. An exemplary trading network environment for implementing trading systems and methods according to at least some embodiments is shown in FIG. 1. The implemented trading systems and methods can include systems and methods that determine the existence of various currency unavailability conditions and take actions in response. The implemented trading systems and methods can include systems and methods in which a futures contract or other financial instrument may be denominated in a primary currency, but in which cash flows associated with the futures contract or other financial instrument are unconditionally converted to a secondary currency.

Computer system 100 can be operated by a financial exchange. Computer system 100 receives orders, transmits market data related to orders and trades to users, and performs other operations associated with a financial exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106. A currency unavailability module 140 may be included within exchange computer system 100 for determining whether certain conditions exist with regard to a currency designated for use in satisfying obligations under contracts of a particular type, and for taking appropriate action in those conditions. Those conditions and actions are discussed in more detail below.

A clearinghouse module 142 may be included as part of exchange computer system 100 and configured to carry out clearinghouse operations. Module 142 may receive data from trade database 108 regarding trades of futures contracts and other financial instruments and facilitate the financial exchange acting as one of the parties to every traded contract or other instrument. For example, computer system 100 may match an offer by party A to sell a futures contract for commodity X with a bid by party B to purchase a futures contract for commodity X. Module 142 may then create a first commodity X futures contract between party A and the financial exchange and an offsetting second commodity X futures contracts between the financial exchange and party B. Module 142 may also be configured to perform other clearinghouse operations. As another example, module 142 may maintain margin accounts for member brokers. In those accounts, module 142 may store and maintain data regarding the values of various contracts and other instruments, determine mark-to-market and final settlement amounts, confirm receipt and/or payment of amounts due from margin accounts, etc.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer using a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include, e.g., other clearing systems, regulatory systems and fee systems.

The operations of computer devices and systems shown in FIG. 1 may be controlled by computer-executable instructions stored on a non-transitory computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

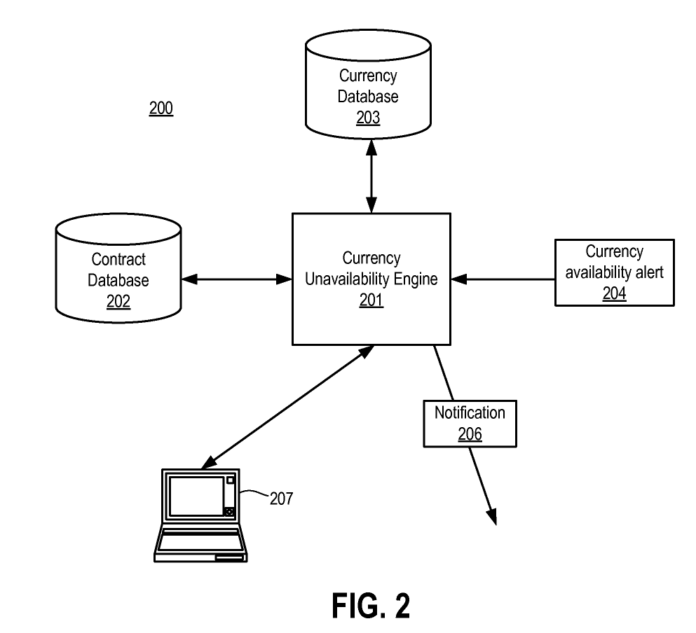

FIG. 2 is a block diagram of a system 200, according to some embodiments, that is configured to determine whether one or more currency unavailability conditions exist and to take certain actions under such conditions. System 200 can be implemented as (or as part of) currency unavailability module 140 (FIG. 1), may be implemented as a standalone computer (or system of computers), or may be implemented as part of another system. Currency unavailability engine 201, which may be implemented in the form of one or more microprocessors executing program instructions, interfaces with one or more futures contracts databases 202. Database 202 maintains information regarding various types of futures contracts and options. For each of multiple futures contract and option types, that data may include designated primary and secondary currencies. A primary currency is a currency designated for use in satisfying obligations under contracts of a particular type. A secondary currency is designated for use in satisfying contract obligations if certain unavailability conditions are determined to exist.

Unavailability engine 201 receives various types of data from contracts database 202. As to each of at least some of the contract types for which information is maintained in database 202, engine 201 receives initialization data that includes general contract terms (e.g., commodity, currency or other contract subject matter, contract amount, delivery date, designated primary currency, designated secondary currency, etc.). Engine 201 also receives information that identifies the amount of contracts of a particular type that are outstanding. Engine 201 may receive updates from database 202 regarding outstanding contracts on a periodic or other basis. Database 202 may be implemented as a distributed database residing in one or more of the modules of exchange computer system 100 (FIG. 1), may be implemented as a one or more software routines configured to extract data from one or more of said modules, may be implemented as a standalone database accessible over the Internet or other wide area network, or may be implemented in other ways.

Currency unavailability engine 201 also interfaces with one or more currency databases 203. Database 203 stores information regarding the availability of various types of currencies. This information can be compiled using feeds (not shown) from various governmental and financial institutions regarding available quantities of various currencies, exchange rates of various currencies, short- and long-term historical data regarding availabilities and exchange rates for various currencies, etc. As with contract database 202, currency database 203 can be implemented in various ways.

Engine 201 may also receive alerts 204 that include data regarding availability of one or more types of currencies. Alerts 204 may come from any of multiple sources and may contain any of various types of information regarding potential unavailability of a particular currency. As but one example, an alert 204 could be a communication from a third party advising of difficulty in obtaining a particular currency. As another example, an alert 204 could be a communication from a bank or governmental entity advising of limits on currency availability or of changes in currency exchange rates. As a further example, an alert 204 could be automatically transmitted from database 203 based on information accumulated from multiple sources.

Engine 201 outputs notifications 206 that may authorize modification of the manner in which obligations under futures contracts are satisfied. As explained in more detail below, such notifications can include authorization for obligations under a contract of a particular type to be satisfied using the designated secondary currency and using a particular exchange rate for the secondary currency relative to the primary currency.

Engine 201 may also receive other types of input via one or more computers 207. For example, a human user of computer 207 may provide input to engine 201 that configures engine 201 to generate a particular output instruction 206. Such configuration can include specification of various parameters under which engine 201 may automatically determine that a particular currency unavailability condition has occurred. Such configuration could also include an authorization command. For example, engine 201 could be configured to provide a message to computer 207 based on certain criteria that suggest a particular currency may be unavailable. One or more human users of computer 207 could then review that message and any underlying data that caused the message to be sent. If the user(s) determine(s) that an unavailability condition has occurred with regard to the currency in question (e.g., that insufficient amounts of the currency are available, or are available but under generally uneconomic or otherwise onerous conditions per pre-specified criteria), the user(s) could then cause computer 207 to send a message to engine 201 that causes transmission of instruction 206. The message from computer 207 could include details of the manner in which obligations under contracts of a particular type (or types) may be satisfied in an alternative manner, as discussed below. Alert 204 could also be provided via or to computer 207. Computer 207 may be the same computer on which engine 201 executes and/or may also house one or more of databases 202 and 203. Alternatively, any or all of engine 201, database 202 and database 203 could execute or reside on computers separate from computer 207, with computer 207 communicating with those separate computers over one or more local and/or wide area networks.

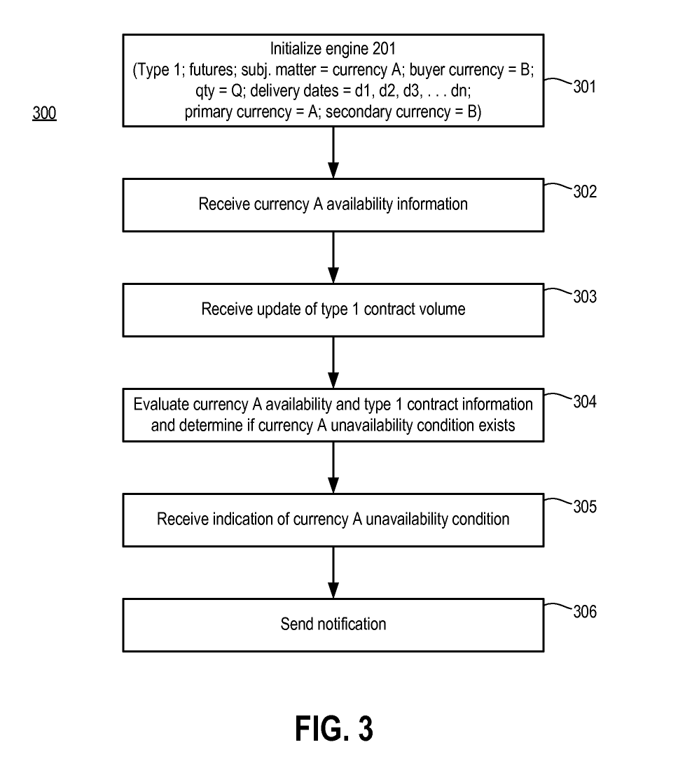

FIG. 3 is a flow chart showing operations in a method 300 according to some embodiments and that can be performed using system 200. Method 300 is initially described using an example of a hypothetical currency exchange contract type. However, this is solely for purposes of illustration and is no way intended as a limitation on the types of multilaterally-traded contracts for which currency unavailability conditions may be detected and action taken in various embodiments.

In step 301, engine 201 is initialized with regard to a particular futures contract type (“type 1”). This initialization could occur automatically or in response to a human operator's command (e.g., a command from an operator of computer 207). In the present example, a type 1 contract is a futures contract having currency A as the subject matter, a designated quantity (Q) of which is delivered in return for payment of currency B. In other words, each instance of a type 1 contract will obligate a seller to deliver the specified quantity Q of currency A at a specified delivery date for an agreed amount of currency B to be paid by a buyer. The contract size (quantity Q of currency A to be delivered) may be standard for all type 1 contracts. There may be a limited number of possible delivery dates d1 through dn. For example, all type 1 contracts may specify delivery on the 3rd Wednesday of a month, and the longest allowed term of a type 1 contract may be n−1 months. Because the contract price (i.e., the amount of currency B to be paid for the standardized quantity of currency A) may be negotiated between the buyer and seller for each individual instance of a type 1 contract, the contract price may not be part of the initialization information. However, such information might be received in step 303 as part of updates regarding values of type 1 contracts.

The initialization data for type 1 contracts also designates a primary currency and a secondary currency. In the present example, the primary currency is currency A and the secondary currency is currency B. This need not be the case, however. As but one alternative, a contract type could designate a third currency (e.g., currency C) as the secondary currency.

In step 302, engine 201 receives information regarding availability of currency A. This information may be received from database 202, from one or more alerts 204, and/or from other sources. The availability information may provide an estimate of the quantity of currency A available on the world, or in a specified local, market, the current exchange rates for and amount of currency A available from each of multiple sources, interest rates for borrowing currency A, forecasts of availability and/or exchange rates for currency A in upcoming time periods, etc. As with step 301, step 302 could occur automatically or in response to a command resulting from input by a human operator into computer 207. For example, an operator of computer 207 may receive one or more indications from separate sources of potential unavailability or recent exchange rate spikes with regard to currency A. Based on such indications, the operator of computer 207 could provide input causing engine 201 to retrieve currency A information from database 203.

In step 303, engine 201 receives an update from database 202 indicating the volume of type 1 contracts outstanding. For example, this update may indicate the total number of outstanding type 1 contracts scheduled for delivery on each of the next delivery dates throughout the next N months, where N is the longest term type 1 contract available. As indicated above, the update could also include information regarding values of outstanding type 1 contracts, e.g., the contracted amount in each contract that the buyer has agreed to pay for the quantity Q of currency A.

As with steps 301 and 302, updating of engine 201 in step 303 could occur in response to a command resulting from input by a human operator into computer 207. Step 303 could also occur automatically. As one example, engine 201 could be configured to automatically retrieve information regarding outstanding type 1 contracts if there are certain triggers in the currency A data received in step 302. Such triggers could include information indicating events consistent with unavailability of currency A, e.g., receipt of an alert 204 (or receipt of a predetermined number of alerts 204), a rise of the average currency A exchange rate by more than a predetermined percentage of its current value or by more than some other amount, a drop in the estimated worldwide supply of currency A below a certain level, an increase in currency A lending rates beyond a particular level or amount, a news report regarding events in the country issuing currency A, etc. As another example, engine 201 could be configured to periodically download updates from information database 202 regardless of whether there are triggers in the data received in step 302.

In step 304, the information regarding currency A and regarding type 1 contracts is evaluated. Based on that evaluation, a determination is made regarding whether an unavailability condition has occurred with regard to currency A. This determination could be made automatically by engine 201. For example, engine 201 could be configured to compare an estimated amount of currency A available on the world market with the volume of type 1 contracts that will become due in the next month (or in the next several months). If the estimated supply of currency A is less than a predefined multiple of the type 1 contract volume, an unavailability condition could be deemed to occur. As another alternative, an average current exchange rate for currency A could be compared to exchange rates in preceding periods. If the current average exchange rate exceeds a value calculated from one or more previous period exchange rates by a certain amount, an unavailability condition could be declared.

Step 304 could also include a human decision regarding whether an unavailability condition for currency A has occurred. This decision could be based on objective or subjective criteria. As part of this decision process, information regarding type 1 contracts and currency A availability that was received at engine 201 is also received at computer 207. As engine 201 receives information during steps 301-303 in some embodiments, for example, engine 201 may forward that information to computer 207. That forwarded information can then be output by computer 207 and used by one or more persons to determine if an unavailability condition exists.

In some embodiments, engine 201 may automatically receive (or retrieve) information in steps 301-303, but only send that information to computer 207 under certain circumstances. For example, engine 201 could be configured to transmit a message to computer 207 in response to, and alerting a computer 207 user of, certain events that are consistent with unavailability of currency A. Such events could include receipt of an alert 204 (or receipt of a predetermined number of alerts 204), a rise of the average currency A exchange rate above some level, a drop in the estimated worldwide supply of currency A below a certain level, an increase in currency A lending rates beyond a particular level or amount, a news report regarding events in the country issuing currency A, etc.

If it is determined in step 304 that a currency A unavailability condition does not exist, the method could conclude. In the example of FIG. 3, however, a currency A unavailability condition is found to exist. Accordingly, in step 305 engine 201 receives an indication of that currency A unavailability condition. If the determination of step 304 was made automatically within engine 201, the indication could be the output of that automatic determination. If the determination in step 304 was made by a human, the indication could be a signal received from computer 207, which signal may be sent as a result of computer 207 receiving an indication from a human user that an unavailability condition exists.

In step 306, engine 201 sends notification 206 to one or more of the elements of exchange computer system 100 and/or otherwise disseminates notification 206 to market participants. The content of notification 206 can be preconfigured or could be determined in some other manner. For example, an operator of computer 207 could provide some or all of the notice 206 content when providing an indication of the currency A unavailability condition to engine 201 in step 305.

The content of notification 206 can vary. Notification 206 could include an instruction that, until further notice, all type 1 contracts may or must be settled using an amount of currency B equivalent to the contract size (quantity Q in the present example) of currency A, and may further include an exchange rate to be used in calculating that equivalent amount of currency B. Notification 206 might also indicate that other payments associated with type 1 contracts could be made using equivalent amounts of currency B. In some cases, e.g., if the currency A unavailability condition is believed to be short-term, notification 206 might only authorize currency B equivalency payments for type 1 contracts that mature (e.g., that have delivery dates) in the next period or in the next few periods.

In some cases, it might be determined in step 304 that a currency A unavailability condition has occurred, but that there is a sufficient supply of currency A to permit some type 1 contract settlements and/or payments to be made using currency A. Accordingly, notification A could further include information indicating a portion of type 1 contract payments for which currency A is to be used and a portion of type 1 contract payments for which an equivalent amount of currency B is to be used. An allocation between currency A payments and currency B equivalency payments could be implemented in multiple ways. For example, and as indicated above, currency B equivalency payments might only be authorized for older type 1 contracts with near-term delivery dates. As another example, currency B equivalency payments might only be authorized for a randomly selected subset of all type 1 contracts. As yet another example, currency B equivalency payments might only be authorized for a portion of payments due under each type 1 contract (e.g., require each type 1 contract to be settled 50% by currency A delivery and 50% by currency B equivalency payments). As but another example, currency B equivalency payments might only be authorized for parties holding more than a certain amount of type 1 contracts.

For simplicity, embodiments have thus far been described using an example of a single type of futures contract. Other embodiments may operate in connection with more generalized and more complicated circumstances. Instead of a single type of futures contract for currency A, there could be multiple additional types: a type 2 contract requiring delivery of currency A for payment of currency C, a type 3 contract requiring delivery of currency A for payment of currency D, etc. There could also be numerous other types of contracts that designate currency A as a primary currency, but which require delivery of a commodity other than currency A (e.g., a futures contract for an agricultural or industrial commodity that requires cash settlement in currency A). There might also be various options for any of the futures contract types that designate currency A as a primary currency. And of course, all of these other contract and option types might exist in a market where there are a large number of futures contract types that do not designate currency A as primary (and/or that may not implicate currency A in any way).

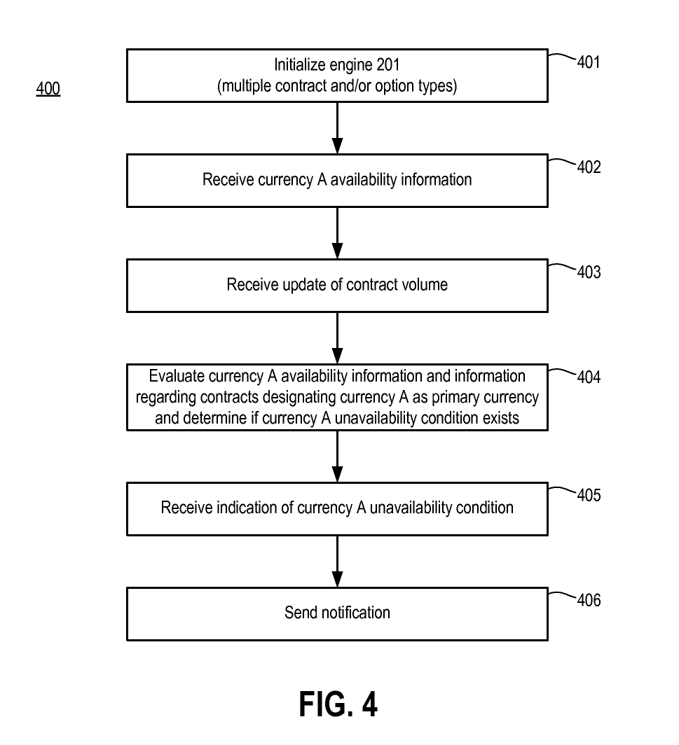

FIG. 4 is a flow chart showing operations in a method 400 according to some embodiments. Method 400 can also be performed using system 200 and is similar to method 300 of FIG. 3. However, method 400 assumes the existence of numerous types of contracts and options that designate currency A as the primary currency, as well as numerous other types of contracts and options that do not designate (and/or do not implicate) currency A.

In step 401, engine 201 is initialized with regard to, and provided with data regarding, the multiple types contracts and options that designate currency A as a primary currency. Although many of those contract types also designate a secondary currency, some may designate currency B as secondary, some may designate currency C as secondary, some may designate currency D as secondary, etc. In step 1, engine 201 is also initialized with regard to (and provided data regarding) numerous other types of contracts and options that do not implicate currency A.

In step 402, engine 201 receives information regarding availability of currency A. During step 402, however, engine 201 might also receive information regarding other currencies. Engine 201 could receive information in step 402 any of the ways described in connection with step 302 of FIG. 3.

In step 403, engine 201 receives one or more updates from database 202 indicating the volume of all types of contracts and options for which currency A is designated as the primary currency. During step 403, however, engine 201 might also receive one or more updates from database 202 indicating the volume for types of contracts and options that do not implicate currency A. Engine 201 could receive updates in step 403 any of the ways described in connection with step 303 of FIG. 3.

In step 404, the information regarding currency A and the information regarding all contracts and options that designate currency A as primary currency contracts is evaluated. Based on that evaluation, a determination is made regarding whether an unavailability condition has occurred with regard to currency A. This determination can be made automatically by engine 201 or with human involvement in ways similar to those described in connection with step 304 of FIG. 3.

In the example of FIG. 4, a currency A unavailability condition is found to exist. Accordingly, in step 405 engine 201 receives an indication of that currency A unavailability condition. This indication can be received in ways similar to those described in connection with step 305 of FIG. 3.

In step 406, engine 201 sends notification 206 to one or more of the elements of exchange computer system 100 and/or otherwise disseminates notification 206 to market participants. The content of notification 206, which can be set in ways similar to those discussed in connection with FIG. 3, can also vary in ways similar to those described in connection with FIG. 3. For example, notification 206 could include an instruction that, until further notice, all contracts designating currency A as the primary currency may be settled (and/or other obligations under such contracts paid) using an amount of the designated secondary currency equivalent to the contract amount, and may further include exchange rates to be used in calculating equivalent amounts of the secondary currencies. As another example, notification 206 might only authorize secondary currency equivalency payments for contracts that designate currency A as the primary currency and that mature in the next period or in the next few periods. Any of the currency A/currency B allocation techniques previously described could also be used to allocate between currency A payments and payment in an equivalent amount of a designated secondary currency.

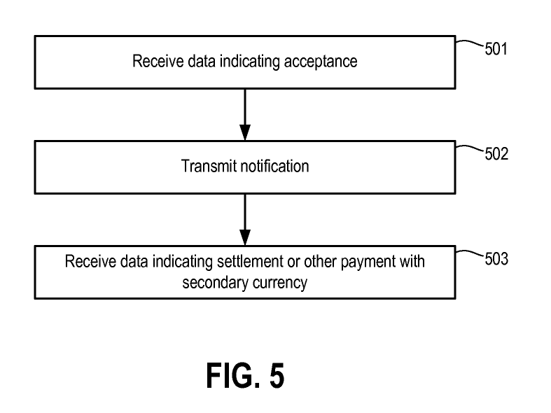

FIG. 5 is a flow chart showing steps that may be performed in connection with a futures contract or other multi-laterally traded and/or cleared contract that designates primary and secondary currencies. The steps shown in FIG. 5 could be performed in the system of FIG. 1 as operations resulting from execution of computer-readable instructions. Beginning in step 501, exchange computer system 100 receives data indicating acceptance of an offer (or bid) for a futures contract that designates primary and secondary currencies. At a later date, and as shown in step 502, a notification authorizing settlement or other payment in an equivalent amount of the designated secondary currency is transmitted. In step 503, data regarding the contract is received, which data indicates that settlement or other payment has been made with an equivalent amount of the secondary currency instead of with the primary currency.

As another more specific example, futures contracts could designate Chinese Renminbi or Yuan (RMB or CNY) as the primary currency and the U.S. Dollar (USD) as the secondary currency. Historically, RMB (or CNY) has not been freely convertible to other currencies. In response to the increasing global economic significance of the People's Republic of China, however, the People's Bank of China (PBC) has taken steps to liberalize use of RMB in offshore locations such as Hong Kong. An offshore market in RMB, known as the CNH market, is rapidly growing. The PBC has also announced intentions to allow U.S. entities to transact in RMB. Currently, futures in RMB are quoted in “American terms,” or USD per RMB. However, new types of RMB futures contracts could be quoted in “European terms,” or RMB per USD. These new contracts could be cash-settled at the RMB per USD fixing rate published by PBC at 9:15 a.m. (Beijing time) and currently published by Reuters SAEC page opposite “USDCNY=”. Although these new contracts could employ a cash settlement, the contracts could alternately provide for a physical delivery of RMB vs. USD, facilitated through an exchange-designated settlement bank.

Currently, however, offshore CNH is not fully convertible with onshore RMB. Accordingly, these new contract types could, similar to contract types discussed in connection with description of other embodiments, utilize procedures in the event that RMB is not available to support RMB-denominated daily mark-to-market payments, RMB-denominated final mark-to-market payments for cash-settled contracts, or physical delivery of RMB. If circumstances are such that one or more clearing members of an exchange is required to make RMB-denominated payments but is unable to do so because of circumstances beyond that member's control, the exchange may authorize satisfaction of such required payments in USD. The amount of USD to be paid could be determined by the amount of RMB due converted into USD by reference to a current RMB per USD rate. The exchange could have sole discretion to authorize payment in USD instead of RMB under circumstances that could include illiquidity in the offshore RMB market, inconvertibility of RMB, non-transferability of RMB, etc. One of these new type contracts could include a “standard” sized futures contract (or an option on futures) nominally based on USD 100,000 and quoted in minimum increments of 0.0010 RMB per USD=100 RMB. Another of these new type contracts could include a “micro” sized futures contract (or an option on futures) nominally based on USD 10,000 and quoted in minimum increments of 0.0010 RMB per USD=10 RMB.

Embodiments described herein can be combined with embodiments described in the aforementioned commonly-owned application titled “Interest Accrual Provisions for Multi-Laterally Traded Contracts.”

In some embodiments, a multi-laterally traded futures or other derivative contract can be denominated in a primary currency. Margin account adjustments for mark-to-market (MTM) settlements, final settlements, and/or other cash flows associated with the contract can initially be calculated based on the primary, denominated currency, but then be converted to an alternate, secondary currency. This conversion can occur unconditionally and without requiring a prior unavailability determination.

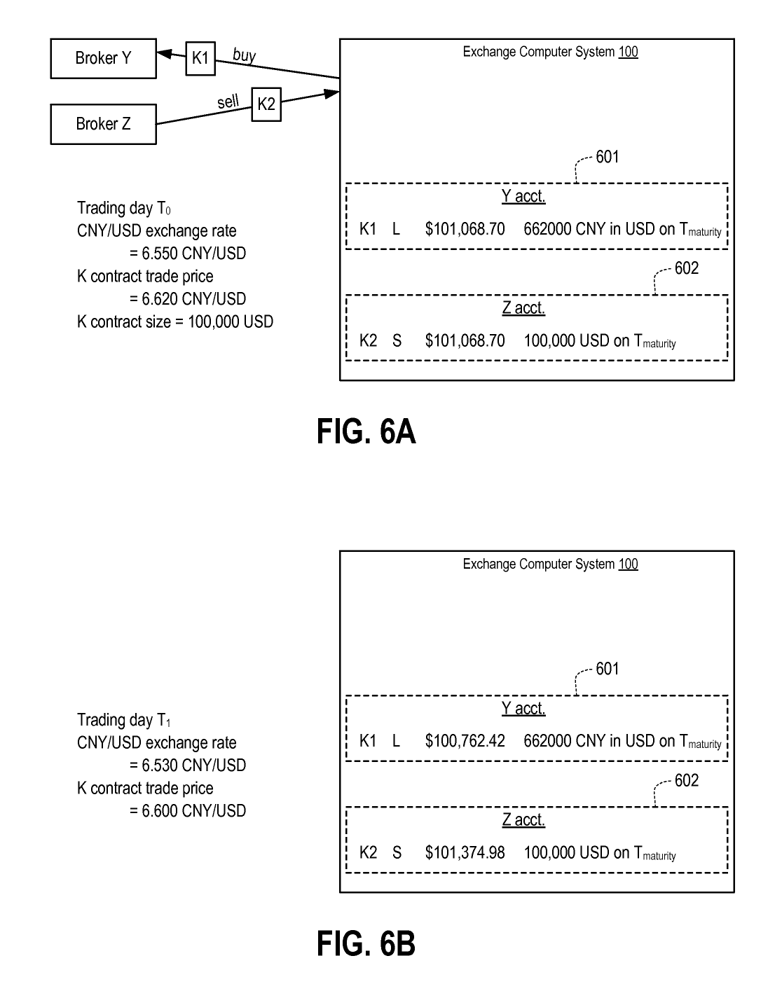

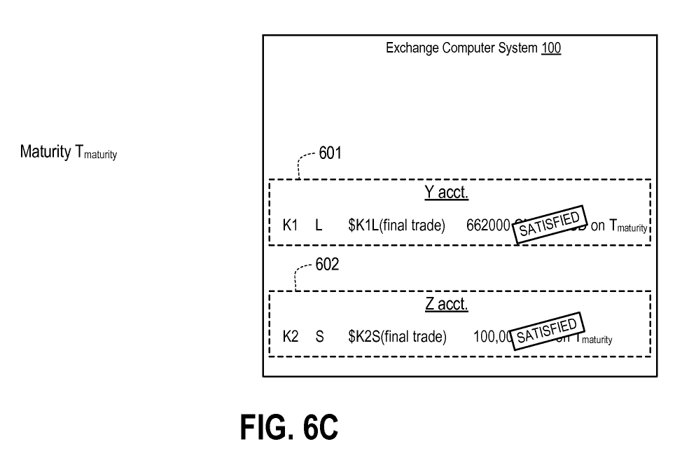

FIGS. 6A through 6C are block diagrams showing examples of operations in connection with an alternate currency derivative contract according to some embodiments. In the examples of FIGS. 6A-6C, the financial exchange that operates computer system 100 (FIG. 1) offers a standardized, multi-laterally traded futures contract of type K. K contracts mature on a date T_{maturity}. The seller of a K contract agrees to provide a contract quantity of U.S. dollars (USD) on T_{maturity}. The buyer of a K contract agrees to purchase that quantity of dollars on T_{maturity} for an amount that is denominated in Chinese RMB (CNY)(the primary currency), but that will be paid in an equivalent amount of USD (the secondary currency). MTM settlements and other settlement amounts are calculated in CNY, but are converted to USD at a currently prevailing rate. In addition to final settlement, MTM settlements and other cash flows are made in the converted USD amounts. Trading in K contracts terminates a contractually established number of days before T_{maturity} on day T_{final trade}.

In the examples of FIGS. 6A-6C, the financial exchange operates a clearinghouse. That clearinghouse maintains a margin account for each clearinghouse member. Although FIG. 6A shows two broker members Y and Z for purposes of illustration, a typical exchange clearinghouse may have many more members, and those members need not be brokers. Each margin account can store data indicating the positions of the corresponding member, the current values of each of those positions, and the obligation(s) of the member associated with each position. In particular, each account can contain data identifying a financial interest (e.g., a futures contract), the nature of the interest (e.g., whether the member is long or short), a current value of the interest, and what the member must do to fulfill the contract at final settlement. Depending on the terms of an agreement between the financial exchange and a member, exchange rules, government regulations, and other factors, a member may be required to maintain some percentage of an obligation (or value thereof) on deposit with the clearinghouse, or maintain some other form of collateral to secure an obligation.

The examples of FIGS. 6A-6C show account 601 corresponding to broker Y and account 602 corresponding to broker Z. Accounts 601 and 602, as well as other margin accounts, can be maintained by clearinghouse module 142 (FIG. 1). For example, data for such margin accounts can be stored in one or more memory devices associated with or otherwise accessible by module 142. One or more processors of clearinghouse module 142 can perform margin account calculations, store and retrieve margin account data from memory, interface with other modules of exchange computer system 100 and/or other computers (e.g., one or more of the other computers shown in FIG. 1), etc. Although accounts 601 and 602 are depicted as simple tables for simplicity, data associated with accounts 601 and 602 could be stored in any convenient manner. In FIGS. 6A-6C, each margin account only shows a single alternate currency derivative contract interest, a corresponding value, and a corresponding obligation. However, each account could include numerous other interests, with each interest having a corresponding value and obligation.

Turning to FIG. 6A, broker Y purchases a first K contract (K1) on day T₀. At the time contract K1 is purchased, K contracts are trading at 6.620 CNY per USD. Broker Y, the holder of contract K1, has thus notionally agreed to provide 662,000 CNY (100,000*6.620) for 100,000 USD on T_{maturity}. Clearinghouse module 142 (not shown) of exchange computer system 100 updates margin account 601 to reflect the purchase of contract K1. This update includes data identifying contract K1, data indicating a long position (“L”) and data indicating the obligations of broker Y as the K1 contract holder (“662,000 CNY in USD on T_{maturity”}). For convenience, the long position of broker Y in contract K1 is hereinafter referred to as “K1L.”

Clearinghouse module 142 also updates margin account 601 to include data indicating the initial value of K1L. This initial value is calculated in CNY and then converted to USD prior to updating margin account 601. The initial CNY value of K1L is 662,000 CNY, the CNY-denominated price at which K1L could theoretically be traded immediately after it was purchased by broker A (and the price at which broker Y could sell an offsetting K contract immediately after purchasing K1). Prior to updating account 601, that initial CNY value of K1 is converted to USD at a currently prevailing exchange rate. In the current example, the prevailing exchange rate at the time contract K1 is purchased is 6.550 (6.550 CNY per USD). Thus, the initial alternate currency value of K1L is $101,068.70 (662,000±6.550).

Also on day 0, broker Z sells a separate K contract (K2). The trade price of K2 is also 6.620. Broker Z, as the seller of contract K2, agrees that it will provide 100,000 USD at T_{maturity} in return for the USD equivalent of 662,000 CNY, with that equivalent amount determined based on an exchange rate prevailing at T_{maturity}. Exchange computer system 100 updates margin account 602 to reflect the purchase of contract K2. This update includes data identifying contract K2, data indicating a short position (“S”) and data indicating the obligations of broker Z as the K2 contract seller (“100,000 USD on T_{maturity}”). For convenience, the short position in contract K2 is hereinafter referred to as “K2S.” Computer system 100 also updates account 602 to include data indicating the initial value of K2S. In the present example, the initial CNY value of K2S is also 662,000 CNY, the CNY-denominated price at which K2S could theoretically be traded immediately after it was sold by broker Z (and the price at which broker Z could purchase an offsetting K contract immediately after selling K2). As with the initial value of K1L, the CNY-denominated initial value of K2S is converted to USD at the prevailing rate (6.550) to $101,068.70 prior to updating margin account 602 to reflect the initial alternate currency value of K2S.

Although FIG. 6A only shows 2 instances of K contracts, hundreds or thousands of other K contracts could also be outstanding. Interests in those other K contracts could be held by broker Y, by broker Z, and/or by other parties. There may also be hundreds or thousands of outstanding contracts similar to K, but which have different maturity dates. For simplicity, it has been assumed that the price of K contracts and the prevailing CNY/USD exchange rate remain constant throughout day T₀. As a result, the initial CNY-denominated and USD-converted values of K1L and K2S are the same, and those values at the end of day T₀ remain unchanged from their initial values. As explained below, however, this need not be the case.

FIG. 6B shows trading day T₁, with trading day T₁ being the trading day immediately following T₀. At the end of T₁, broker Y has remained long in contract K1. Similarly, broker Z has remained short in contract K2 through the end of T₁. The closing price of K contracts is 6.600 and the CNY/USD exchange rate is 6.530 at the end of day T₁.

FIG. 6B further shows the effects of MTM settlement of K1L and K2S at the end of day T₁. The value of K1L at the end of day T₁ is equal to the previous day's closing value plus a daily value change. That change is determined by first subtracting the CNY value of K1L at the end of day T₀ (662,000 CNY) from the CNY value of a K contract based on the day T₁ closing price (660,000). This difference (−2,000 CNY) is then converted to USD by dividing by the exchange rate prevailing at the end of day T₁ (6.530). The resulting change in value of K1L from day T₀ to day T₁ is thus (−2000)/(6.530) USD, or −306.28 USD. At the end of day T₁, the value of K1L in account 601 has thus decreased to 100,762.42 USD (i.e., $101,068.70-$306.28). The value of K2S at the end of day 1 can calculated in a similar manner, except that the sign of the day 0 to day 1 value difference is reversed to reflect the opposite effect of the drop in K contract trade price on a short position. Thus, the USD value of K2S in account 602 at the end of day T₁ has increased to 101,374.98 USD (i.e., $101,068.70+$306.28).

MTM calculations and account updating would then be performed at the end of each trading day, up to and including T_{final trade}. In at least some embodiments, those calculations would be performed in a manner similar to that shown in connection with FIG. 6B. To calculate MTM settlement for an arbitrary trading day Tⱼ, for example, the CNY value of a K contract at the last trade price on the immediately preceding trading day Tⱼ₋₁ is subtracted from the CNY value of a K contract at the last trade price on day Tⱼ. That CNY-denominated difference is then converted to USD at the exchange rate prevailing on day Tⱼ. The USD-converted amount is then added to the value of K1L and subtracted from the value of K2S. If K1L or K2S were transferred to another party, the MTM calculations would be performed in a similar manner, but the resulting value change would be added to or subtracted from the value in an account of the transferee.

As indicated above, the current example assumed in FIG. 6A that the trade price of K contracts remained constant throughout day T₀. This often may not be the case, as the trade price of a particular type of futures contract may vary throughout a trading day. Had the trade price of K contracts changed on day T₀ between purchase of K1 and sale of K2, the initial CNY values of K1L and K2S could be different. A variation in K contract price after trading of K1 and/or of K2 might also have necessitated an MTM adjustment of account 601 and/or account 602 at the close of day T₀. A variation in the CNY/USD conversion rate during day T₀ could also have impacted the K1L and K2S values. For example, the initial value of K1L and K2S were both calculated by converting the initial CNY-denominated contract value (662,000 CNY) to an alternate currency (USD) based on the exchange rate (6.550) prevailing at the time of the K1 and K2 trades. If that exchange rate changed between the time of the K1 and K2 trades, the initial CNY-denominated values of K1L and K2S would have been converted to USD at different rates. As another example, and had an MTM adjustment been necessary at the end of day T₀ because of a change in the K contract trade price during day T₀, the change in the CNY-denominated values of K1L and/or K2S at the end of day T₀ might be converted to USD using an exchange rate other than the rate(s) used to convert the initial CNY-denominated values of K1L and K2S to USD. In some embodiments, fluctuations in a primary/secondary currency exchange rate throughout a single day are ignored, and a single exchange rate is used for all conversions associated with a particular day. For example, all K contracts could specify that all primary/secondary currency conversions associated with a particular day are performed using an exchange rate published by a specified source at the beginning of that day.

FIG. 6C shows final settlement of accounts 601 and 602 on T_{maturity}. FIG. 6C assumes that, on the last day of trading T_{final trade}, the USD values of K1L and K2S after M™ settlement at the close of T_{final trade} were $K1L(final trade) and $K2S(final trade), respectively. As can be appreciated from the above discussion, values $K1L(final trade) and $K2S(final trade) would depend on the closing K contract trade price and prevailing CNY/USD exchange rate on each trading day from T₀ through T_{final trade}. At the maturity date T_{maturity}, broker Y fulfills its obligation under contract K1 by delivering an amount of alternate currency (USD) equivalent to 662,000 CNY. That equivalent amount is calculated based on the CNY/USD exchange rate prevailing on T_{maturity}. That exchange rate could be different from the CNY/USD exchange rate prevailing on T_{final trade}. Upon delivery of the USD equivalent to 662,000 CNY by broker Y, exchange computer system 100 updates account 601 to indicate satisfaction of the obligation associated with K1L. Also on maturity date T_{matunty}, broker Z fulfills its obligation under contract K2 by delivering 100,000 USD. Upon that delivery of 100,000 USD, exchange computer system 100 updates account 602 to indicate satisfaction of the obligation associated with K2S.

Although the examples of FIGS. 6A-6C show a futures contract for which the trade price continually falls while an exchange rate also continues to fall, this need not be the case. The calculations described above also apply in cases where a futures contract trade price and/or applicable exchange rate rise, as well as cases where a futures contract trade price and/or exchange rate rise and fall numerous times throughout the life of a contract. Moreover, the numerical values used in the examples of FIGS. 6A-6C are merely intended to illustrate the manner in which calculations can be made according to some embodiments. Those numerical values do not necessarily reflect an actual set of conditions. However, the application of the methods described herein to actual trade prices, exchange rates and other real-world market phenomena is apparent to persons of ordinary skill after review of the disclosures herein.

In some cases, the value of a futures contract interest at final settlement may be the same as the initial value at which the holder of the interest acquired the interest. For example, on day T_{final trade}, K contracts may have been trading at 6.620. Even in such a “scratch” scenario, however, holding of K1L may have resulted in a net loss or net profit to broker Y. Depending on daily fluctuations in K contract trade price and CNY/USD exchange rate, the value of MTM settlements over the time period broker Y held K1L may not net to zero. Similarly, the value of MTM settlements over the time period broker Z held K2S may not net to zero.

Although the examples of FIGS. 6A-6C are based on a futures contract in which the denominated, primary currency is Chinese RMB and the alternate, secondary currency is U.S. dollars, this need not be the case. Other currencies could be chosen for the primary and/or the secondary currencies. Furthermore, the invention is not limited to currency futures contracts. In certain other embodiments, other types of futures contracts could utilize a similar denominated/alternate currency arrangement. As but one example thereof, a petroleum futures contract could specify delivery of 1000 barrels of crude oil on a maturity date and be denominated in Chinese RMB (or some other denominated currency). Daily MTM settlement could be calculated in a manner similar to that described above in connection with FIG. 6B. If the petroleum futures contract includes a provision permitting cash settlement at maturity, final settlement associated with maturity could be calculated in a manner similar to that described above in connection with FIG. 6C.

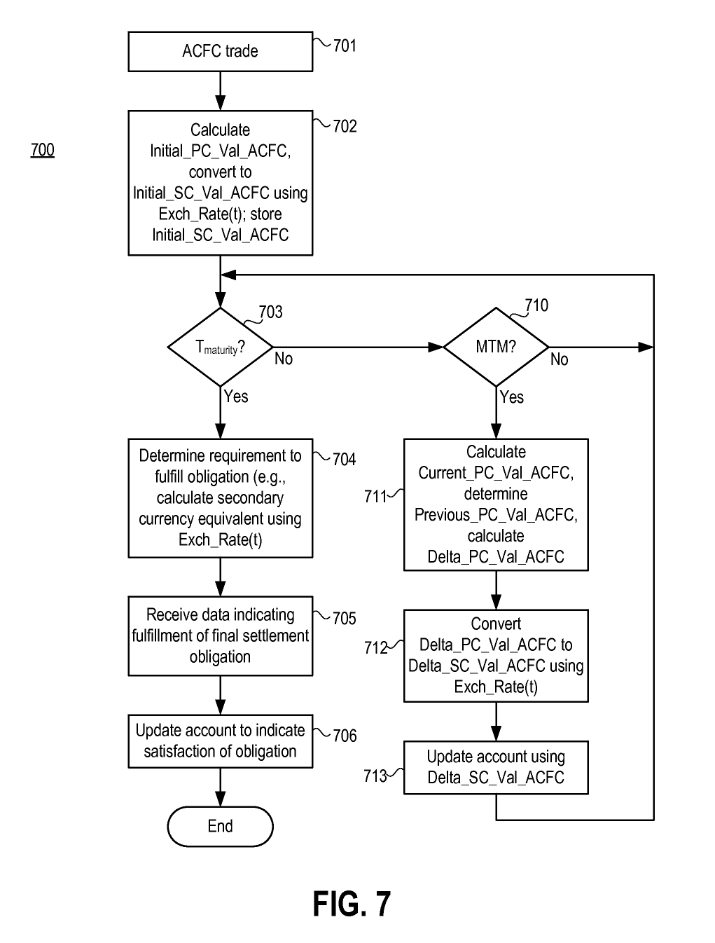

FIG. 7 is a flow chart showing operations in a method 700, according to at least some embodiments, by which alternate currency derivatives can be traded and by which data associated with those derivatives can be processed. Although FIG. 7 shows operations related to a single futures contract or interest therein, a computer system (e.g., exchange computer system 100 of FIG. 1) may perform numerous concurrent instances of method 700 in connection with numerous separate futures contracts or interests therein.

Beginning in block 701, an alternate currency futures contract (“ACFC”) is traded. The ACFC is denominated in a primary currency. Margin account adjustments for M™ settlements, final settlements, and/or other cash flows associated with the ACFC are initially calculated based on the primary currency, but are then converted to an alternate, secondary currency. This conversion can occur unconditionally and without requiring a prior unavailability determination. The ACFC could be a currency futures contract similar to K contracts of FIGS. 6A-6C, could be a commodity futures contract similar to the petroleum futures contract described above, or could be another type of alternative currency derivative. The trade of the ACFC could be a purchase resulting in a long position or a sale resulting in a short position.

In block 702, one or more modules of the computer system (e.g., clearinghouse module 142) calculates Initial_PC_Val_ACFC, the initial value of the traded ACFC interest in the denominated primary currency. The computer system then converts Initial_PC_Val_ACFC to an initial value of the ACFC interest in the secondary currency (Initial_SC_Val_ACFC) using a predesignated exchange rate (Exch_Rate(t)) that can vary over time. The computer system then stores data representing Initial_SC_Val_ACFC in an account associated with the holder of the ACFC interest. The initial value calculations and storage described in connection with FIG. 6A are examples of operations that could be performed in block 702. As used in connection with FIG. 7, “predesignated exchange rate” refers to a rate that is specified by the ACFC prior to initial purchase or sale of the ACFC. The specified rate need not (and typically will not) be fixed. For example, the rate may be specified by, e.g., specifying a source of published exchange rates and the applicable day and/or time at which a rate published by that source should be obtained for a particular calculation. As one further example, if ACFC is a K contract, the specified rate could be, for all conversions occurring on an arbitrary day i, the spot value of RMB per USD as published by the People's Bank of China (PBC) on day i. As indicated above, the PBC publishes an RMB per USD fixing rate published by at 9:15 a.m. (Beijing time), which rate is currently published by Reuters SAEC page opposite “USDCNY=”.

In block 703, the computer system then determines if the ACFC has matured. If so, the computer system proceeds to block 704 on the “yes” branch. Blocks 704 through 706 are discussed below. If the computer system determines in block 703 that the ACFC has not matured, the computer system proceeds to block 710 on the “no” branch.

In block 710, the computer system determines if it is time for an MTM determination. In some embodiments, this comprises determining if a trading day has ended and if the current date is on or before a date of final trading specified by the ACFC. If it is not time for an MTM determination, the computer system returns to block 703 on the “no” branch from block 710. If it is time for an MTM determination, the computer system proceeds on the “yes” branch to block 711.

In block 711, the computer system calculates Current_PC_Val_ACFC, a primary currency value of the ACFC interest based on the last closing trade price of contracts that are the same as the ACFC. The computer system then determines Previous_PC_Val_ACFC, a previously-calculated primary currency value the ACFC. If block 711 is reached for the first time in connection with performance of method 700 for the ACFC interest, Previous_PC_Val_ACFC is set equal to Initial_PC_Val_ACFC. If block 711 is reached for the second or subsequent times in connection with performance of method 700 for the ACFC interest, Previous_PC_Val_ACFC is set equal to the value of Current_PC_Val_ACFC calculated during the immediately preceding pass through block 711. The computer system then calculates Delta PC_Val_ACFC by subtracting Previous_PC_Val_ACFC from Current_PC_Val_ACFC. An example of the calculations of block 711 includes the calculation of the CNY-denominated value change of −2,000 CNY described in connection with FIG. 6B.

Next, in block 712, the computer system converts Delta PC_Val_ACFC from the immediately preceding performance of block 711 to an equivalent secondary currency value (Delta_SC_Val_ACFC) using the predesignated exchange rate Exch_Rate(t). In at least some embodiments, and as indicated above, the predesignated exchange rate is a published exchange rate in effect at the time of the conversion operation in block 712. An example of the conversion of block 712 includes the conversion of −2000 CNY to −306.28 USD described in connection with FIG. 6B.

In block 713, the computer system updates the margin account of the holder of the ACFC interest using Delta_SC_Val_ACFC from the immediately preceding performance of block 712. Examples of the updating of block 713 include the updating of the K1L value in account 601 to 100,762.42 USD, and the updating of the K2S value in account 602 to 101,374.98 USD, described in connection with FIG. 6B.

From block 713, the computer system returns to block 703. If the computer system determines in block 703 that the ACFC has matured, the computer system proceeds to block 704 on the “yes branch.” In block 704, the computer system determines what is required to fulfill the obligations of the holder of the ACFC interest. If final settlement of ACFC requires delivery of a secondary currency equivalent amount of an amount denominated in the primary currency, the computer system calculates the secondary currency equivalent amount using the exchange rate Exch_Rate(t). An example of this type of calculation includes the calculation of the USD equivalent to 662,000 CNY discussed in connection with FIG. 6C.

Next, in block 705, the computer system receives data indicating that the final settlement obligations determined in block 704 have been fulfilled. The received data could include data indicating a secondary-currency equivalent amount calculated in block 704 has been delivered (e.g., tendered, paid, or otherwise made available). The received data could alternately include data indicating a contracted—for amount of the secondary currency has been delivered. The received data could include, for physically-settled futures contracts, data indicating that a commodity has been delivered.

In block 706, the computer system updates account data for the ACFC interest to indicate satisfaction of the obligation of the holder of the ACFC interest. Process 700 then ends.

Various embodiments encompass numerous variations on the systems and methods described in connection with FIGS. 6A through 7. As indicated above, for example, currencies other than CNY could be designated as primary and currencies other than USD could be designated as secondary. As another example, exchange rates and daily contract values could be determined in different ways. As a further example, primary/secondary currency conversions need not be performed for all monetary transactions, e.g., a currency futures contract could specify that primary/secondary currency conversions are performed for MTM settlements but that the contract obligor has the option of delivering the primary currency at final settlement. As yet another example, trading need not terminate prior to final settlement. As an additional example, various modifications could be made to the algorithms described above. For instance, when determining a change in contract value, a current contract value in a primary currency could be subtracted from a previous contract value in the primary (instead of vice versa), with appropriate modification of other arithmetic operations in the value change determination. All steps described in connection with FIGS. 6A-7 need not be performed in all embodiments, and steps may be rearranged, combined and/or otherwise modified.

As used herein, a “computer system” could be a single computer or could comprise multiple computers. When a computer system comprising multiple computers performs a method, various steps could be performed by different ones of those multiple computers.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that the steps illustrated in the illustrative figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
(a) calculating, by a computer system and for each of a plurality of multilaterally-traded contracts, a change in contract value in an amount of a primary currency;
(b) converting, by the computer system and for each multilaterally-traded contract of the plurality, the change in contract value from the amount of the primary currency calculated in (a) to an amount of a secondary currency using an exchange rate designated by the contract;
(c) updating, by the computer system and for each multilaterally-traded contract of the plurality, and based on the amount of the secondary currency calculated in (b), data in an account corresponding to a holder of an interest in the contract; and
(d) repeating (a) through (c) for at least one subsequent time period.

2. The method of claim 1, wherein each multilaterally-traded contract of the plurality is a currency futures contract identifying a maturity date, an amount of the secondary currency to be delivered on the maturity date, and a notional amount of the primary currency to be delivered on the maturity date in return for the amount of the secondary currency to be delivered on the maturity date.

3. The method of claim 2, further comprising:
(e) calculating, by the computer system and for each multilaterally-traded contract of the plurality, an amount of the secondary currency based on the notional amount of the primary currency and the exchange rate designated by the contract;
(f) receiving, by the computer system and for each multilaterally-traded contract of the plurality, data indicating delivery of the amount of the secondary currency calculated in (e); and
(g) storing, by the computer system and for each multilaterally-traded contract of the plurality, and based on the data received in (f), data indicating satisfaction of an obligation under the contract.

4. The method of claim 3, wherein (a) comprises
(a1) determining a value of the contract, in a preceding period, in an amount of the primary currency,
(a2) determining a value of the contract, in a current period and in an amount of the primary currency, based on a current period trade price of like contracts, and
(a3) subtracting one of the amount determined in (a1) and the amount determined in (a2) from the other of the amount determined in (a1) and the amount determined in (a2).

5. The method of claim 4, wherein
each multilaterally-traded contract of the plurality is a currency futures contract identifying a notional amount of the primary currency, and
(a1) comprises, for a first performance of (a), calculating an initial value of the contract in the primary currency based on the notional amount of the primary currency.

6. The method of claim 4, wherein the value of the exchange rate designated by the contract is different for each performance of (b) and for performance of (e).

7. The method of claim 1, wherein each multilaterally-traded contract of the plurality is a commodity futures contract identifying a maturity date, an amount of a commodity to be delivered on the maturity date, and a notional amount of the primary currency to be delivered on the maturity date in return for the amount of the commodity to be delivered on the maturity date.

8. The method of claim 7, wherein (a) comprises
(a1) determining a value of the contract, in a preceding period, in an amount of the primary currency,
(a2) determining a value of the contract, in a current period and in an amount of the primary currency, based on a current period trade price of like contracts, and
(a3) subtracting one of the amount determined in (a1) and the amount determined in (a2) from the other of the amount determined in (a1) and the amount determined in (a2).

9. The method of claim 1, wherein the computer system is a computer system of a financial exchange.

10. The method of claim 1, wherein the value of the exchange rate designated by the contract is different for each performance of (b).

11. One or more non-transitory computer-readable media storing computer executable instructions that, when executed, cause a computer system to perform operations that include:
(a) calculating, for each of a plurality of multilaterally-traded contracts, a change in contract value in an amount of a primary currency;
(b) converting, for each multilaterally-traded contract of the plurality, the change in contract value from the amount of the primary currency calculated in (a) to an amount of a secondary currency using an exchange rate designated by the contract;
(c) updating, for each multilaterally-traded contract of the plurality, and based on the amount of the secondary currency calculated in (b), data in an account corresponding to a holder of an interest in the contract; and
(d) repeating (a) through (c) for at least one subsequent time period.

12. The one or more non-transitory computer-readable media of claim 11, wherein each multilaterally-traded contract of the plurality is a currency futures contract identifying a maturity date, an amount of the secondary currency to be delivered on the maturity date, and a notional amount of the primary currency to be delivered on the maturity date in return for the amount of the secondary currency to be delivered on the maturity date.

13. The one or more non-transitory computer-readable media of claim 12, wherein the stored instructions further comprise instructions that, when executed, cause the computer system to perform operations that include:
(e) calculating, for each multilaterally-traded contract of the plurality, an amount of the secondary currency based on the notional amount of the primary currency and the exchange rate designated by the contract;
(f) receiving, for each multilaterally-traded contract of the plurality, data indicating delivery of the amount of the secondary currency calculated in (e); and
(g) storing, for each multilaterally-traded contract of the plurality, and based on the data received in (f), data indicating satisfaction of an obligation under the contract.

14. The one or more non-transitory computer-readable media of claim 13, wherein (a) comprises
(a1) determining a value of the contract, in a preceding period, in an amount of the primary currency,
(a2) determining a value of the contract, in a current period and in an amount of the primary currency, based on a current period trade price of like contracts, and
(a3) subtracting one of the amount determined in (a1) and the amount determined in (a2) from the other of the amount determined in (a1) and the amount determined in (a2).

15. The one or more non-transitory computer-readable media of claim 14, wherein
each multilaterally-traded contract of the plurality is a currency futures contract identifying a notional amount of the primary currency, and
(a1) comprises, for a first performance of (a), calculating an initial value of the contract in the primary currency based on the notional amount of the primary currency.

16. The one or more non-transitory computer-readable media of claim 11, wherein each multilaterally-traded contract of the plurality is a commodity futures contract identifying a maturity date, an amount of a commodity to be delivered on the maturity date, and a notional amount of the primary currency to be delivered on the maturity date in return for the amount of the commodity to be delivered on the maturity date.

17. The one or more non-transitory computer-readable media of claim 16, wherein (a) comprises
(a1) determining a value of the contract, in a preceding period, in an amount of the primary currency,
(a2) determining a value of the contract, in a current period and in an amount of the primary currency, based on a current period trade price of like contracts, and
(a3) subtracting one of the amount determined in (a1) and the amount determined in (a2) from the other of the amount determined in (a1) and the amount determined in (a2).

18. A computer system comprising:
at least one processor; and
at least one non-transitory memory, wherein the memory stores instructions that, when executed, cause the computer system to perform operations that include
(a) calculating, for each of a plurality of multilaterally-traded contracts, a change in contract value in an amount of a primary currency,
(b) converting, for each multilaterally-traded contract of the plurality, the change in contract value from the amount of the primary currency calculated in (a) to an amount of a secondary currency using an exchange rate designated by the contract,
(c) updating, for each multilaterally-traded contract of the plurality, and based on the amount of the secondary currency calculated in (b), data in an account corresponding to a holder of an interest in the contract, and
(d) repeating (a) through (c) for at least one subsequent time period.

19. The computer system of claim 18, wherein each multilaterally-traded contract of the plurality is a currency futures contract identifying a maturity date, an amount of the secondary currency to be delivered on the maturity date, and a notional amount of the primary currency to be delivered on the maturity date in return for the amount of the secondary currency to be delivered on the maturity date, and wherein the memory stores instructions that, when executed, cause the computer system to perform operations that include
(e) calculating, for each multilaterally-traded contract of the plurality, an amount of the secondary currency based on the notional amount of the primary currency and the exchange rate designated by the contract,
(f) receiving, for each multilaterally-traded contract of the plurality, data indicating delivery of the amount of the secondary currency calculated in (e), and
(g) storing, for each multilaterally-traded contract of the plurality, and based on the data received in (f), data indicating satisfaction of an obligation under the contract.

20. The computer system of claim 19, wherein (a) comprises
(a1) determining a value of the contract, in a preceding period, in an amount of the primary currency,
(a2) determining a value of the contract, in a current period and in an amount of the primary currency, based on a current period trade price of like contracts, and
(a3) subtracting one of the amount determined in (a1) and the amount determined in (a2) from the other of the amount determined in (a1) and the amount determined in (a2).
